(19) United States
(12) Patent Application Publication
(10) Pub. No.: US 2006/0034531 A1
(43) Pub. Date: Feb. 16, 2006

(54) Block noise level evaluation method for compressed images and control method of imaging device utilizing the evaluation method

(75) Inventors: Eunice Poon, Ontario (CA); Megumi Kanda, Tokyo (JP); Ian Clarke, Ontario (CA)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/125,326

(22) Filed: May 10, 2005

(30) Foreign Application Priority Data
May 10, 2004 (JP) JP2004-140063
May 10, 2004 (JP) JP2004-140064

(51) Int. Cl. G06K 9/36; G06K 9/40

(52) U.S. Cl. 382/239; 382/268

(57) ABSTRACT

The technique of the invention converts an object RGB image into an image in a YIQ color space, calculates a luminance variation at each target pixel from Y channel values of the target pixel and an adjacent pixel adjoining to the target pixel, and computes a smoothness degree of luminance variation at the target pixel as summation of absolute values of differences between luminance variations at the target pixel and adjacent pixels. A block noise evaluation value B is obtained as a ratio of an average smoothness degree ave(psx), ave(psy) of luminance variation for boundary pixels located on each block boundary to an average smoothness degree ave(nsx), ave(nsy) of luminance variation for inner pixels not located on the block boundary. The block noise evaluation value B closer to 1 gives an evaluation result of a lower level of block noise, whereas the block noise evaluation value B closer to 10 gives an evaluation result of a higher level of block noise.

### BACKGROUND OF THE INVENTION

1. Field of the Invention

The present invention relates to a block noise level evaluation method, an imaging device, a control method of the imaging device, and an image storage method.

2. Description of the Prior Art

A proposed block noise level evaluation method evaluates the quality of an image based on an intensity difference across each block boundary in a JPEG (Joint Photographic Experts Group)-compressed image, which is obtained by compression in units of blocks having 8 pixels in both horizontal and vertical directions. Another proposed block noise level evaluation method evaluates the quality of an image, based on the measured frequency at each block boundary in the JPEG-compressed image. These prior art techniques have been proposed by cited references 1 and 2 given below:

Reference 1: ‘A generalized Block-Edge Impairment Metric for Video Coding’, H. R. Wu and M, Yen, IEEE Signal Processing Letters, Vol. 4, No. 11, November, 1997

Reference 2: ‘No-Reference Perceptual Quality Assessment of Compressed Images’, Zhou Wang, Hamid R. Sheikh, and Alan C. Bovik, Proceedings of the IEEE International Conference on Image Processing, 22-25 Sep. 2002, Volume 1, Pages 22-25

A proposed imaging device displays each photographed image on a liquid crystal monitor (see, for example, Japanese Patent Laid-Open Gazette No. 2000-209467). This prior art imaging device instantly displays each photographed image on the liquid crystal monitor to enable the user to check the image, and stores the image in a removable storage medium.

### SUMMARY OF THE INVENTION

The proposed block noise level evaluation methods attain efficient evaluation based on simple calculation, but have relatively poor accuracy in some cases. For example, a higher evaluation may be given even in the presence of visually observable block noise.

The proposed imaging device instantly displays each photographed image for the user's visual check, but does not allow the user to check the potential noise that may arise in an image subsequently JPEG (Joint Photographic Experts Group)-compressed and stored in a storage medium. When the original image has a gentle variation in tone or brightness, the compressed image with even a relatively low compression rate is significantly affected by the noise. When the original image has a drastic variation in tone or brightness, on the other hand, the compressed image with even a relatively high compression rate is hardly affected by the noise. Namely the influence level of noise depends upon the type of the original image. One possible measure of reducing the influence level of noise in the compressed image uniformly lowers the compression rate. The lowered compression rate, however, undesirably decreases the number of compressed images storable in the restricted memory capacity of the storage medium.

The block noise level evaluation method of the invention thus aims to adequately evaluate the level of potential block noise. The block noise level evaluation method of the invention also aims to promptly evaluate the level of potential block noise.

The imaging device of the invention and its control method aim to store a compressed image with an adequate compression rate for each photographed image, into a storage medium. The imaging device of the invention and its control method also aim to enable the user to check the influence of potential noise that may arise in a compressed image. The imaging device of the invention and its control method further aim to adequately evaluate the influence of potential noise that may arise in a compressed image.

The image storage method of the invention aims to compress a photographed image with an adequate compression rate and store the compressed image into a storage medium. The image storage method of the invention also aims to adequately evaluate the influence of potential noise that may arise in a compressed image and store the compressed image into a storage medium.

The present invention is directed to a first block noise level evaluation method that evaluates a level of potential block noise arising on each block boundary in a compressed image, which is obtained by compression subsequent to division of an original image into multiple blocks of a preset number of pixels both in a horizontal direction and in a vertical direction. The first block noise level evaluation method includes the steps of: (a) calculating a luminance variation at each target pixel in the compressed image from luminance values of the target pixel and of an adjacent pixel adjoining to the target pixel in a preset direction; (b) computing a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction; (c) computing a block noise evaluation index from a specific ratio of an average smoothness degree of luminance variation for boundary pixels located on the block boundary to an average smoothness degree of luminance variation for inner pixels not located on the block boundary; and (d) evaluating the level of potential block noise corresponding to the computed block noise evaluation index.

The first block noise level evaluation method of the invention calculates the luminance variation at each target pixel in the compressed image from the luminance values of the target pixel and of the adjacent pixel adjoining to the target pixel in the preset direction, and computes the smoothness degree of luminance variation at the target pixel from the anterior difference between the calculated luminance variations at the target pixel and the anterior pixel adjoining to the target pixel in the preset direction and the posterior difference between the calculated luminance variations at the target pixel and the posterior pixel adjoining to the target pixel in the preset direction. The first block noise level evaluation method then computes the block noise evaluation index from the specific ratio of the average smoothness degree of luminance variation for the boundary pixels located on the block boundary to the average smoothness degree of luminance variation for the inner pixels not located on the block boundary, and evaluates the level of potential block noise corresponding to the computed block noise evaluation index. Namely this method evaluates the level of potential block noise, based on the smoothness degrees of luminance variation for the boundary pixels and for the inner pixels. This arrangement ensures adequate evaluation of the level of potential block noise. The series of computation is standardized and thus ensures prompt evaluation of the level of potential block noise.

In the first block noise level evaluation method of the invention, the preset direction may include both the vertical direction and the horizontal direction. In this case, the step (c) may compute the block noise evaluation index from an average of the specific ratio in the vertical direction and the specific ratio in the horizontal direction.

Further, in the first block noise level evaluation method of the invention, the preset direction may be either one of the vertical direction and the horizontal direction. Also, the step (a) may set a difference between the luminance values of the target pixel and of the adjacent pixel adjoining to the target pixel in the preset direction to the luminance variation at the target pixel. Also, the step (b) may set summation of absolute values of the anterior difference between the luminance variations at the target pixel and the anterior pixel in the preset direction and the posterior difference between the luminance variations at the target pixel and the posterior pixel in the preset direction to the smoothness degree of luminance variation at the target pixel.

Moreover, in the first block noise level evaluation method of the invention, the step (c) may compute the block noise evaluation index to increase with a rise in level of potential block noise. In this case, the step (c) may compute the block noise evaluation index to have a numerical value in a value range of 1 to 10.

The present invention is also directed to a second block noise level evaluation method that evaluates a level of potential block noise arising on each block boundary in a compressed image, which is obtained by compression subsequent to division of an original image into multiple blocks of a preset number of pixels. The second block noise level evaluation method includes the steps of: (a) calculating a luminance variation at each target pixel in the compressed image from luminance values of the target pixel and of an adjacent pixel adjoining to the target pixel in a preset direction; (b) computing a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction; and (c) evaluating the level of potential block noise, based on the computed smoothness degrees of luminance variation for boundary pixels located on the block boundary.

The second block noise level evaluation method of the invention calculates the luminance variation at each target pixel in the compressed image from the luminance values of the target pixel and of the adjacent pixel adjoining to the target pixel in the preset direction, and computes the smoothness degree of luminance variation at the target pixel from the anterior difference between the calculated luminance variations at the target pixel and the anterior pixel adjoining to the target pixel in the preset direction and the posterior difference between the calculated luminance variations at the target pixel and the posterior pixel adjoining to the target pixel in the preset direction. The second block noise level evaluation method then evaluates the level of potential block noise, based on the computed smoothness degrees of luminance variation for the boundary pixels located on the block boundary. Namely this method evaluates the level of potential block noise, based on the smoothness degrees of luminance variation for the boundary pixels. This arrangement ensures adequate evaluation of the level of potential block noise. The series of computation is standardized and thus ensures prompt evaluation of the level of potential block noise.

The present invention is also directed to a control method of an imaging device that stores a compressed image, which is obtained by compression subsequent to division of an original image into multiple blocks of a preset number of pixels both in a horizontal direction and in a vertical direction, into a storage medium. The control method includes the steps of: (a) evaluating a level of potential block noise arising on each block boundary in the compressed image; and (b) when the evaluated level of potential block noise is greater than a preset level, regenerating a compressed image with a reduced compression rate and reevaluating the level of potential block noise in the regenerated compressed image in said step (a), when the evaluated level of potential block noise is not greater than the preset level, storing the compressed image into the storage medium.

The control method of the imaging device of the invention evaluates the level of potential block noise arising on each block boundary in the compressed image, which is obtained by compression subsequent to division of the original image into multiple blocks of the preset number of pixels both in the horizontal direction and in the vertical direction. When the evaluated level of potential block noise is greater than a preset level, the control method regenerates a compressed image with a reduced compression rate and reevaluates the level of potential block noise in the regenerated compressed image. When the evaluated level of potential block noise is not greater than the preset level, the control method stores the compressed image into the storage medium. This arrangement enables storage of the compressed image with the potential block noise of not greater than the preset level. This ensures storage of a compressed image with an adequate compression rate for each photographed image.

In the control method of the imaging device of the invention, the step (a) may calculate a luminance variation at each target pixel in the compressed image from luminance values of the target pixel and of an adjacent pixel adjoining to the target pixel in a preset direction, compute a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction, compute a block noise evaluation index from a specific ratio of an average smoothness degree of luminance variation for boundary pixels located on the block boundary to an average smoothness degree of luminance variation for inner pixels not located on the block boundary, and evaluate the level of potential block noise corresponding to the computed block noise evaluation index. In this case, the preset direction may include both the vertical direction and the horizontal direction. Further, the step (a) may compute the block noise evaluation index from an average of the specific ratio in the vertical direction and the specific ratio in the horizontal direction. Also, the preset direction may be either one of the vertical direction and the horizontal direction. Moreover, said step (a) may set a difference between the luminance values of the target pixel and of the adjacent pixel adjoining to the target pixel in the preset direction to the luminance variation at the target pixel. Also, the step (a) may set summation of absolute values of the anterior difference between the luminance variations at the target pixel and the anterior pixel in the preset direction and the posterior difference between the luminance variations at the target pixel and the posterior pixel in the preset direction to the smoothness degree of luminance variation at the target pixel. Also, the step (a) may compute the block noise evaluation index to increase with a rise in level of potential block noise.

Further, in the control method of the imaging device of the invention, the step (b) may generate a compressed image with a predetermined compression rate set to a default. Also, when the evaluated level of potential block noise is greater than the preset level, the step (b) may sequentially select one of preset compression rates, which decrease stepwise, regenerate a compressed image with the selected compression rate and store the compressed image.

Moreover, in the control method of the imaging device of the invention, the control method may further include the step of: (c) displaying the evaluated level of potential block noise. In this case, the step (c) may display the evaluated level of potential block noise by at least either of numerical representation and graphical representation. Also, in response to a user's instruction of generating a compressed image with a reduced compression rate, the step (b) may generate the compressed image with the reduced compression rate and store the compressed image.

The present invention is also directed to an imaging device that stores a compressed image, which is obtained by compression subsequent to division of an original image into multiple blocks of a preset number of pixels both in a horizontal direction and in a vertical direction, into a storage medium. The imaging device has a controller that performs control to evaluate a level of potential block noise arising on each block boundary in the compressed image, and when the evaluated level of potential block noise is greater than a preset level, to regenerate a compressed image with a reduced compression rate and to reevaluate the level of potential block noise in the regenerated compressed image, when the evaluated level of potential block noise is not greater than the preset level, to store the compressed image into the storage medium.

The imaging device of the invention evaluates the level of potential block noise arising on each block boundary in the compressed image, which is obtained by compression subsequent to division of the original image into multiple blocks of the preset number of pixels both in the horizontal direction and in the vertical direction. When the evaluated level of potential block noise is greater than a preset level, the imaging device regenerates a compressed image with a reduced compression rate and reevaluates the level of potential block noise in the regenerated compressed image. When the evaluated level of potential block noise is not greater than the preset level, the imaging device stores the compressed image into the storage medium. This arrangement enables storage of the compressed image with the potential block noise of not greater than the preset level. This ensures storage of a compressed image with an adequate compression rate for each photographed image.

The present invention is also directed to a first image storage method that stores an image. The first image storage method includes the steps of: (a) generating a compressed image by compression subsequent to division of an original image into multiple blocks of a preset number of pixels both in a horizontal direction and in a vertical direction; (b) evaluating a level of potential block noise arising on each block boundary in the compressed image; and (c) when the evaluated level of potential block noise is greater than a preset level, regenerating a compressed image with a reduced compression rate and reevaluating the level of potential block noise in the regenerated compressed image, and when the evaluated level of potential block noise is not greater than the preset level, storing the compressed image into the storage medium.

The first image storage method of the invention generates the compressed image by compression subsequent to division of the original image into multiple blocks of the preset number of pixels both in the horizontal direction and in the vertical direction, and evaluates the level of potential block noise arising on each block boundary in the compressed image. When the evaluated level of potential block noise is greater than a preset level, the first image storage method regenerates a compressed image with a reduced compression rate and reevaluates the level of potential block noise in the regenerated compressed image. When the evaluated level of potential block noise is not greater than the preset level, the first image storage method stores the compressed image into the storage medium. This arrangement enables storage of the compressed image with the potential block noise of not greater than the preset level.

In the first image storage method of the invention, the step (b) may calculate a luminance variation at each target pixel in the compressed image from luminance values of the target pixel and of an adjacent pixel adjoining to the target pixel in a preset direction, compute a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction, compute a block noise evaluation index from a specific ratio of an average smoothness degree of luminance variation for boundary pixels located on the block boundary to an average smoothness degree of luminance variation for inner pixels not located on the block boundary, and evaluate the level of potential block noise corresponding to the computed block noise evaluation index.

The present invention is also directed to a second image storage method that stores an image. The image storage method includes the step of: when a level of potential block noise is greater than a preset level, generating a compressed image with a reduced compression rate and storing the compressed image, and when the level of potential block noise is not greater than the preset level, generating a compressed image with a predetermined compression rate and storing the compressed image.

When the level of potential block noise is greater than the preset level, the second image storage method of the invention generates a compressed image with a reduced compression rate and stores the compressed image. When the level of potential block noise is not greater than the preset level, the second image storage method generates a compressed image with a predetermined compression rate and stores the compressed image. This arrangement enables storage of the compressed image with the potential block noise of not greater than the preset level.

The present invention is further directed to a third image storage method stores an image. The third image storage method includes the step of, when a level of potential block noise is greater than a preset level, storing a compressed image with a reduced compression rate and a compressed image with a predetermined compression rate.

When the level of potential block noise is greater than the preset level, the third image storage method of the invention stores a compressed image with a reduced compression rate and a compressed image with a predetermined compression rate. This arrangement enables storage of the compressed image with the potential block noise of not greater than the preset level, as well as the compressed image with the predetermined compression rate.

### BRIEF DESCRIPTION OF THE DRAWINGS

FIG. 1 is a flowchart showing a processing routine of block noise level evaluation method in one embodiment of the invention;

FIG. 2 schematically shows calculation of luminance variations;

FIG. 3 is a graph showing one-dimensional curves of the luminance of an image, the luminance variation, and the smoothness degree of luminance variation;

FIG. 4 is a perspective view illustrating the appearance of a digital camera in a first embodiment of the invention;

FIG. 5 is a rear view illustrating a rear face of the digital camera in the first embodiment;

FIG. 6 is a block diagram showing the functional blocks of the digital camera in the first embodiment;

FIG. 7 is a flowchart showing an image storage routine executed in the first embodiment;

FIG. 8 is a flowchart showing another image storage routine executed in a second embodiment of the invention; and

FIG. 9 shows an operation window displayed on a rear face of a digital camera in the second embodiment.

### DESCRIPTION OF THE PREFERRED EMBODIMENTS

Some modes of carrying out the invention are described below as preferred embodiments. The description first regards the block noise level evaluation method of the invention.

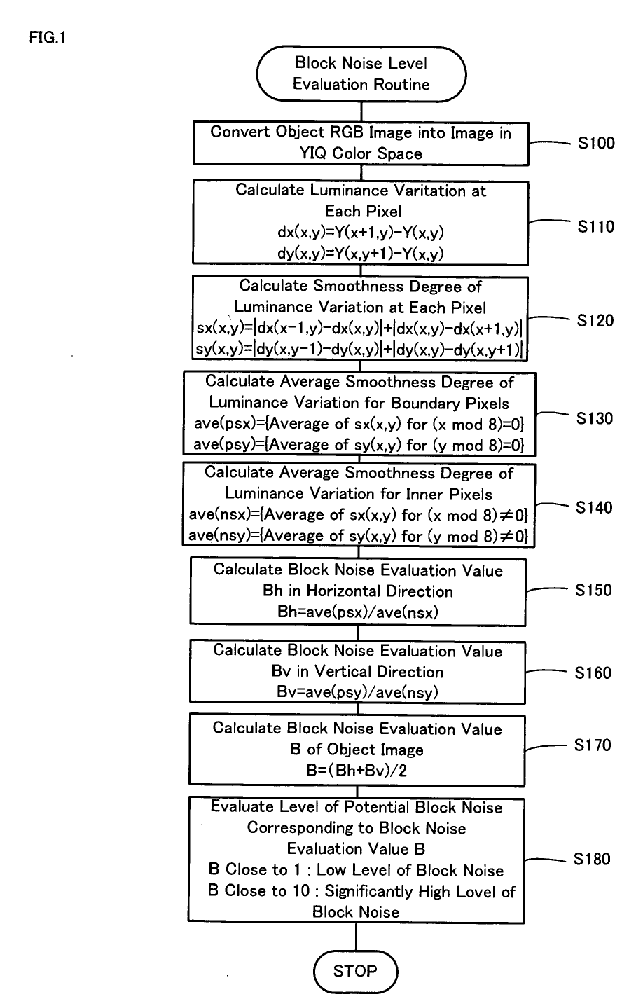

The block noise level evaluation method evaluates the level of potential block noise that may arise on each block boundary in a JPEG (Joint Photographic Experts Group)-compressed image, which is obtained by compression subsequent to division of an original image into multiple blocks of 8 pixels in both horizontal and vertical directions. FIG. 1 is a flowchart showing a processing routine of block noise level evaluation method in one embodiment of the invention. The block noise level evaluation routine first converts an object RGB image, which is expressed in a color system of red (R), green (G), and blue (B) and is JPEG-extended, into a YIQ color space of three primary elements Y (luminance), I (orange-cyan), and Q (green-magenta) according to Equation (1) given below (step S100):

$$( \begin{matrix}Y \\ I \\ Q\end{matrix} ) = ( \begin{matrix}0.299 & 0.587 & 0.114 \\ 0.596 & - 0.274 & - 0.322 \\ 0.211 & - 0.522 & - 0.311\end{matrix} ) ( \begin{matrix}R \\ G \\ B\end{matrix} ) \qquad ( 1 )$$

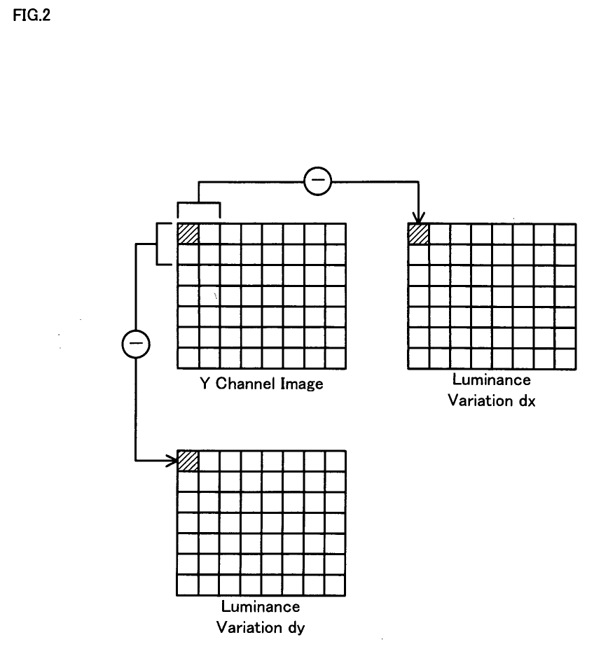

The block noise level evaluation routine then reads the Y channel (luminance) values of the converted image in the YIQ color space and calculates luminance variations at each pixel in both the horizontal direction and the vertical direction (step S110). The procedure of this embodiment calculates the luminance variations according to Equations (2) and (3) given below, where dx(x,y), dy(x,y), and Y(x,y) respectively denote a luminance variation in the horizontal direction, a luminance variation in the vertical direction, and a luminance value at each pixel:
dx(x,y)=Y(x+1,y)−Y(x,y) (2)
dy(x,y)=Y(x,y+1)−Y(x,y) (3)
As clearly understood from Equations (2) and (3), the luminance variation at each target pixel in each of the horizontal and the vertical directions represents a difference between luminance values at the target pixel and an adjacent pixel adjoining to the target pixel in the direction. The calculation of the luminance variation is schematically shown in FIG. 2.

The block noise level evaluation routine subsequently calculates smoothness degrees of luminance variation at each pixel in both the horizontal direction and the vertical direction from the calculated luminance variations (step S120). The procedure of this embodiment calculates the smoothness degrees of luminance variation at each pixel according to Equations (4) and (5) given below, where sx(x,y) and sy(x,y) respectively denote a smoothness degree of luminance variation at each pixel in the horizontal direction and a smoothness degree of luminance variation at each pixel in the vertical direction:
sx(x,y)=|dx(x−1,y)−dx(x,y)|+|dx(x,y)−dx(x+1,y)| (4)
sy(x,y)=|dy(x,y−1)−dy(x,y)|+|dy(x,y)−dy(x,y+1)| (5)

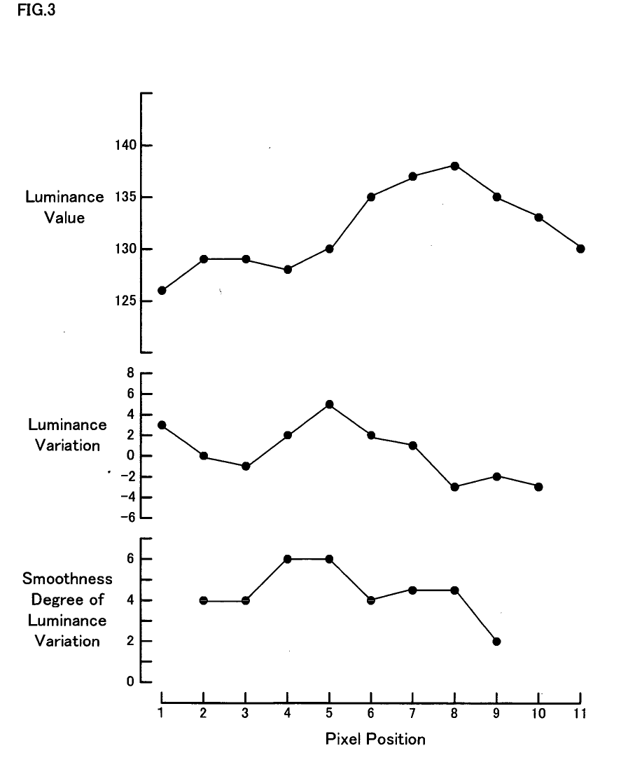

As clearly understood from Equations (4) and (5), the smoothness degree of luminance variation at each target pixel in each of the horizontal and the vertical directions represents summation of the absolute values of an anterior difference between luminance variations at the target pixel and an anterior pixel adjoining to the target pixel in the direction and a posterior difference between luminance variations at the target pixel and a posterior pixel adjoining to the target pixel in the direction. FIG. 3 is a graph showing one-dimensional curves of the luminance of an image, the luminance variation, and the smoothness degree of luminance variation.

After calculation of the smoothness degree of luminance variation at each pixel, the block noise level evaluation routine calculates average smoothness degrees ave(psx) and ave(psy) of luminance variation in the horizontal direction and in the vertical direction with regard to pixels located on each block boundary in JPEG compression (hereafter referred to as boundary pixels) (step S130). Concurrently the block noise level evaluation routine calculates averages smoothness degrees ave(nsx) and ave(nsy) of luminance variation in the horizontal direction and in the vertical direction with regard to pixels other than the boundary pixels (hereafter referred to as inner pixels) (step S140). The average smoothness degree ave(psx) of luminance variation in the horizontal direction for the boundary pixels is obtained by dividing the total sum of the smoothness degrees of luminance variation sx(x,y) with regard to x values equal to multiples of 8 by the number of the x values as the multiples of 8. The average smoothness degree ave(psy) of luminance variation in the vertical direction for the boundary pixels is obtained by dividing the total sum of the smoothness degrees of luminance variation sy(x,y) with regard to y values equal to multiples of 8 by the number of the y values as the multiples of 8. The average smoothness degree ave(nsx) of luminance variation in the horizontal direction for the inner pixels is obtained by dividing the total sum of the smoothness degrees of luminance variation sx(x,y) with regard to x values other than multiples of 8 by the number of the x values as the non-multiples of 8. The average smoothness degree ave(nsy) of luminance variation in the vertical direction for the inner pixels is obtained by dividing the total sum of the smoothness degrees of luminance variation sy(x,y) with regard to y values other than multiples of 8 by the number of the y values as the non-multiples of 8.

A block noise evaluation value Bh in the horizontal direction is given as a ratio {ave(psx)/ave(nsx)} of the average smoothness degree ave(psx) of luminance variation in the horizontal direction for the boundary pixels to the average smoothness degree ave(nsx) of luminance variation in the horizontal direction for the inner pixels (step S150). A block noise evaluation value By in the vertical direction is given as a ratio {ave(psy)/ave(nsy)} of the average smoothness degree ave(psy) of luminance variation in the vertical direction for the boundary pixels to the average smoothness degree ave(nsy) of luminance variation in the vertical direction for the inner pixels (step S160). An average of the block noise evaluation value Bh in the horizontal direction and the block noise evaluation value By in the vertical direction is set to a block noise evaluation value B of the object image (step S170). Each of the block noise evaluation value Bh in the horizontal direction and the block noise evaluation value By in the vertical direction represents the ratio of the average smoothness degree of luminance variation for the boundary pixels to the average smoothness degree of luminance variation for the inner pixels. The block noise evaluation value Bh or By is accordingly close to a value ‘1’ corresponding to a significantly low level of block noise, while gradually increasing from the value ‘1’ with a rise in level of block noise. In the case of a small average smoothness degree of luminance variation for the inner pixels, for example, in an image with a gentle variation in tone or brightness, the average smoothness degree of luminance variation for the boundary pixels is conspicuous to give a large block noise evaluation value B. In the case of a large average smoothness degree of luminance variation for the inner pixels, for example, in an image with a drastic variation in tone or brightness, on the other hand, the average smoothness degree of luminance variation for the boundary pixels is inconspicuous to give a small block noise evaluation value B. The block noise evaluation value B thus adequately represents the level of potential block noise. The level of potential block noise is then evaluated corresponding to the block noise evaluation value B (step S180). The block noise evaluation value B is equal to 1 in the absence of any block noise, while being close to 10 in the presence of significant block noise. The procedure of the embodiment evaluates the level of potential block noise in the value range of 1 to 10.

As described above, the block noise level evaluation method of the embodiment evaluates the level of potential block noise, based on the smoothness degrees of luminance variation for the boundary pixels. This arrangement ensures adequate evaluation of the level of potential block noise. The block noise evaluation value B is given as the ratio of the average smoothness degree of luminance variation for the boundary pixels to the average smoothness degree of luminance variation for the inner pixels. In an image with a gentle variation in tone or brightness, the average smoothness degree of luminance variation for the boundary pixels is conspicuous to give a large block noise evaluation value B. In an image with a drastic variation in tone or brightness, on the other hand, the average smoothness degree of luminance variation for the boundary pixels is inconspicuous to give a small block noise evaluation value B. The evaluation result corresponding to the block noise evaluation value B thus well agrees with the evaluation result by visual inspection. This ensures the adequate evaluation of the level of potential block noise. The block noise evaluation value B varies in the range of 1 to 10. This enables numerical evaluation of the level of potential block noise.

The processing of step S110 to calculate the luminance variations at each pixel in the horizontal direction and in the vertical direction in the block noise level evaluation routine shown in the flowchart of FIG. 1 is equivalent to the step (a) in the block noise level evaluation method of the invention. The processing of step S120 to calculate the smoothness degrees of luminance variation at each pixel in the horizontal direction and in the vertical direction in the block noise level evaluation routine shown in the flowchart of FIG. 1 is equivalent to the step (b) in the block noise level evaluation method of the invention. The processing of steps S130 to S170 to compute the block noise evaluation value B in the block noise level evaluation routine shown in the flowchart of FIG. 1 is equivalent to the step (c) in the block noise level evaluation method of the invention. The processing of step S180 to evaluate the level of potential block noise corresponding to the block noise evaluation value B in the block noise level evaluation routine shown in the flowchart of FIG. 1 is equivalent to the step (d) in the block noise level evaluation method of the invention.

The block noise level evaluation method of the embodiment sets the average of the block noise evaluation value Bh in the horizontal direction and the block noise evaluation value By in the vertical direction to the block noise evaluation value B of the object image. One possible modification may compute only the block noise evaluation value Bh in the horizontal direction and set the computed block noise evaluation value Bh to the block noise evaluation value B of the object image. The possible modification may alternatively compute only the block noise evaluation value By in the vertical direction and set the computed block noise evaluation value By to the block noise evaluation value B of the object image. Such modification desirably reduces the load of calculating the block noise evaluation value B.

The block noise level evaluation method of the embodiment uses the block noise evaluation value B in the range of 1 to 10 to evaluate the level of potential block noise. The block noise evaluation value B is, however, not restricted to this value range but may have any arbitrary value range, for example, a value range of 1 to 100.

The block noise level evaluation method of the embodiment calculates the smoothness degrees of luminance variation with regard to all the pixels included in the object image. One possible modification calculates the smoothness degrees of luminance variation with regard to all the boundary pixels included in the object image, while calculating the smoothness degrees of luminance variation with regard to only part of the inner pixels, for example, pixels having the remainders of 1 and 4 by division of x or y values by 8 or pixels having the remainders of 2 and 6 by division of x or y values by 8.

The block noise level evaluation method of the embodiment evaluates the level of potential block noise that may arise on each block boundary in a JPEG-compressed image, which is obtained by compression subsequent to division of an original image into multiple blocks of 8 pixels in both the horizontal and the vertical directions. This block size is not essential at all, and the block noise level evaluation method may be applied to evaluate the level of potential block noise that may arise on each block boundary in any compressed image, which is obtained by compression subsequent to division of an original image into multiple blocks of any preset number of pixels in the horizontal direction and in the vertical directions.

The block noise level evaluation method may be actualized by a computer program. In this application, the respective steps in the flowchart of FIG. 1 are described in an adequate programming language as respective functions to be executed by the computer.

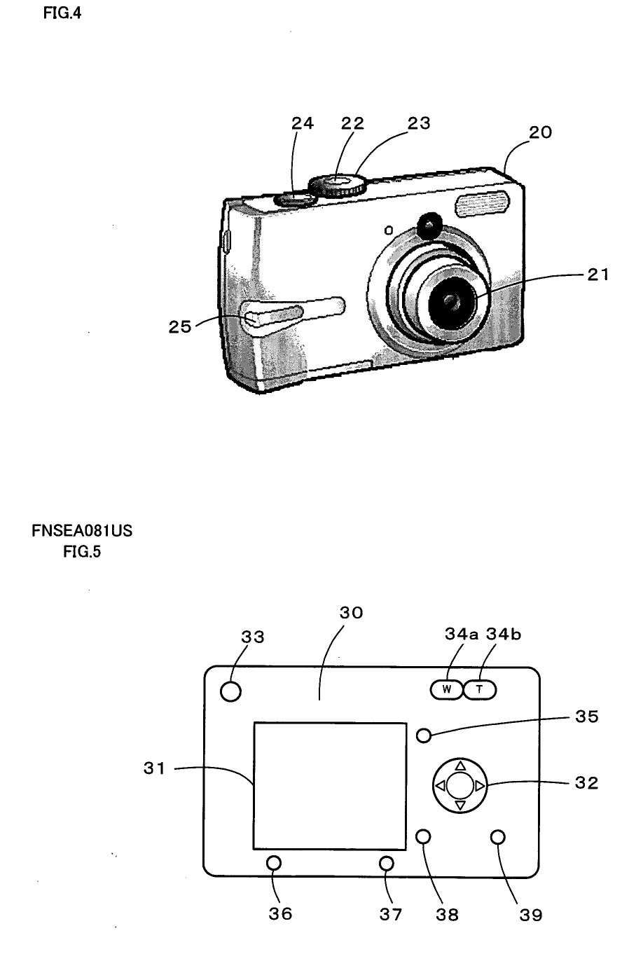

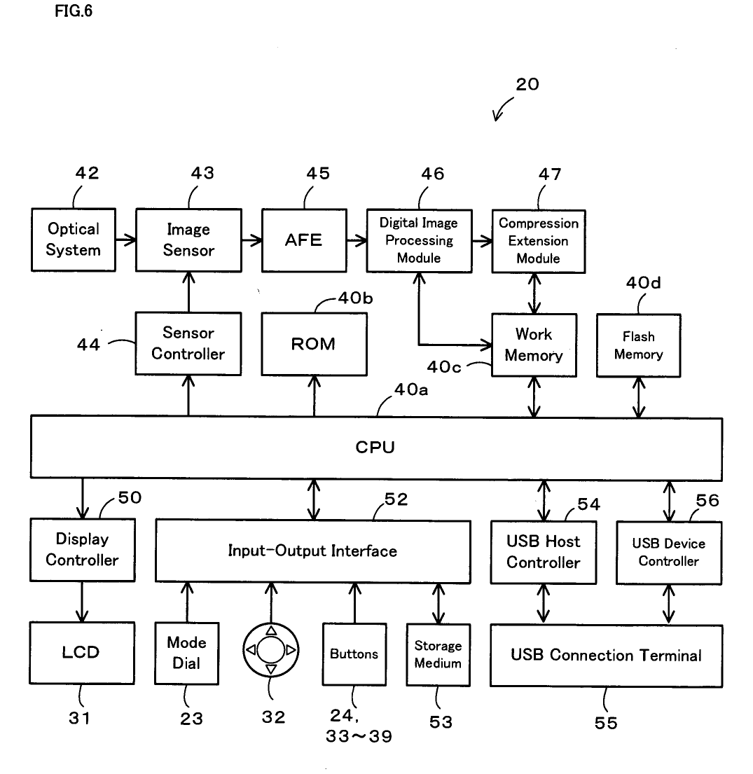

The description below regards the structure of a digital camera 20 as an imaging device in one embodiment of the invention and a control method of the digital camera 20. FIG. 4 is a perspective view illustrating the appearance of the digital camera 20 of the embodiment. FIG. 5 is a rear view illustrating a rear face 30 of the digital camera 20 of the embodiment. FIG. 6 is a block diagram showing the functional blocks of the digital camera 20 of the embodiment.

As illustrated in FIG. 4, a front face of the digital camera 20 of the embodiment has a lens 21 with 3× optical zoom and a self timer lamp 25 that blinks while a self timer is on. A top face of the digital camera 20 has a mode dial 23 for the user's selection of a desired mode, a power button 22 located on the center of the mode dial 23, and a shutter button 24. As illustrated in FIG. 5, the rear face 30 of the digital camera 20 has a liquid crystal display 31 mostly located in the left half, a 4-directional button 32 located on the right of the liquid crystal display 31 to be manipulated by the user in upward, downward, leftward, and rightward directions, a print button 33 located on the upper left corner, and a W button 34a and a T button 34b located on the upper right side for adjustment of the zoom function. The rear face 30 of the digital camera 20 also has a menu button 35 located on the upper left of the 4-directional button 32, an A button 36 and a B button 37 respectively located on the lower left and on the lower right of the liquid crystal display 31, a display button 38 located on the lower left of the 4-directional button 32 for switchover of the display on the liquid crystal display 31, and a review button 39 located on the right of the display button 38.

The digital camera 20 of the embodiment has a CPU (central processing unit) 40a, a ROM 40b for storage of processing programs, a work memory 40c for temporary storage of data, and a flash memory 40d for involatile storage of settings of data as main functional blocks as shown in FIG. 6. An imaging system of the digital camera 20 has an optical system 42 including the lens and a diaphragm, an image sensor 43, a sensor controller 44, an analog front end (AFE) 45, a digital image processing module 46, and a compression extension module 47. The image sensor 43 accumulates charges obtained by photoelectric conversion of an optical image focused by the optical system 42 in each light receiving cell for a preset time period and outputs an electrical signal corresponding to the accumulated amount of light received in each light receiving cell. The sensor controller 44 functions as a driving circuit to output driving pulses required for actuation of the image sensor 43. The AFE 45 quantizes the electrical signal output from the image sensor 43 to generate a corresponding digital signal. The digital image processing module 46 makes the digital signal output from the AFE 45 subject to a required series of image processing, for example, image formation, white balance adjustment, γ correction, and color space conversion, and outputs processed digital image data representing the R, G, and B tone values or Y, Cb, Cr tone values of the respective pixels. The compression extension module 47 performs transform (for example, discrete cosine transform or wavelet transform) and entropy coding (for example, run length encoding or Huffman coding) of the processed digital image data to compress the digital image data, while performing inverse transform and decoding to extend the compressed digital image data. In the digital camera 20 of the embodiment, a display controller 50 includes a frame buffer for storage of data representing one image plane of the liquid crystal display 31, and a display circuit for actuation of the liquid crystal display 31 to display a digital image expressed by the data stored in the frame buffer. An input-output interface 52 takes charge of inputs from the mode dial 23, the 4-directional button 32, and the other buttons 24 and 33 to 39, as well as inputs from and outputs to a storage medium 53, for example, a detachable flash memory. The digital camera 20 of the embodiment also has a USB (Universal Serial Bus) host controller 54 and a USB device controller 56 to control communication with a device (for example, a computer or a printer) connected to a USB connection terminal 55. In the configuration of this embodiment, the compression extension module 47 specifies a compression rate and performs JPEG (Joint Photographic Experts Group) compression to compress image data in the units of blocks having 8 pixels in both the horizontal and the vertical directions into compressed image data. The compression extension module 47 inversely performs JPEG extension to extend the compressed image data to the standard image data. The digital image data processed by the digital image processing module 46 or the digital image data JPEG-compressed or JPEG-extended (compressed or extended) by the compression extension module 47 is temporarily stored in the work memory 40c. After execution of the block noise level evaluation, the image data is written in the storage medium 53 via the input-output interface 52 in the form of an image file with a file name as an ID allocated to the image data in an imaging sequence as described below.

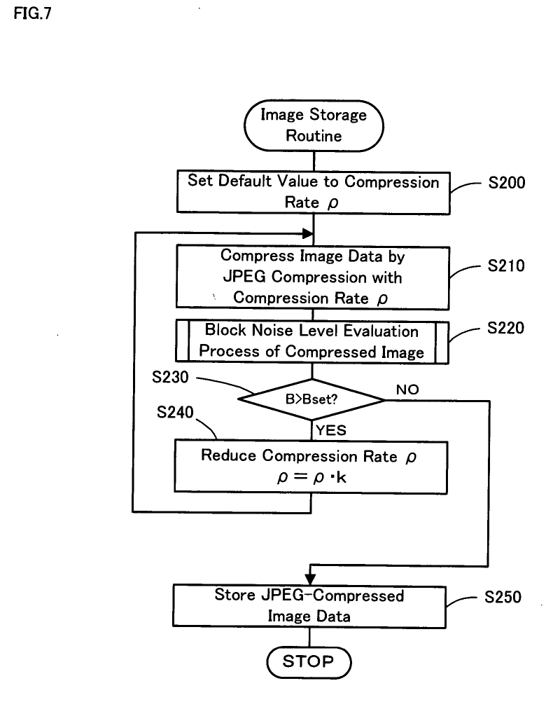

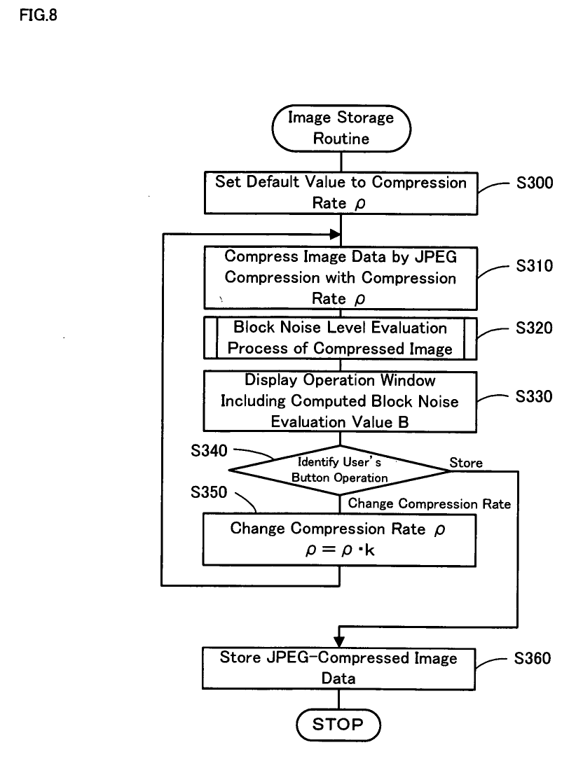

The following description regards the operations of the digital camera 20 of the embodiment configured as discussed above, especially a series of processing to store the image data into the storage medium 53. FIG. 7 is a flowchart showing an image storage routine executed by the CPU 40a to store image data into the storage medium 53. In the image storage routine, the CPU 40a first sets a default value to a compression rate ρ (step S200) and compresses object image data by JPEG compression with the set compression rate ρ (step S210). The default value of the compression rate ρ is set to a level with little influence of potential noise (block noise), which may arise on each block boundary in a JPEG-compressed image obtained by compression of an original image with a significant variation in tone or brightness. The compression extension module 47 causes the image data processed by the digital image processing module 46 and temporarily stored in the work memory 40c to be subjected to the JPEG compression with the set compression rate p. As mentioned above, the JPEG-compressed image data is stored in the work memory 40c.

The CPU 40a then evaluates the level of potential block noise in the JPEG-compressed image (step S220). The evaluation of the level of potential block noise follows the block noise level evaluation method described in detail above with reference to the flowchart of FIG. 1.

The block noise evaluation value B computed in the block noise level evaluation process is compared with a preset reference value Bset (step S230). The reference value Bset is set to a sufficiently small value that is incapable of evaluation of the block noise level by visual inspection, for example, 1.5, 2, or 2.5. When the computed block noise evaluation value B is greater than the preset reference value Bset, the CPU 40a determines that the compressed image has a significantly high level of block noise and multiplies the compression rate ρ by a reduction factor k, which is greater than 0 but is smaller than 1, to reduce the compression rate ρ (step S240). The image storage routine then goes back to step S210 to compress the image data stored in the work memory 40c by JPEG compression with the reduced compression rate ρ. Until it is determined at step S230 that the computed block noise evaluation value B decreases to or below the preset reference value Bset, the processing of steps S210 to S240 is repeated to reduce the compression rate ρ, compress the image data by JPEG compression with the reduced compression rate ρ, and compute the block noise evaluation value B.

When the computed block noise evaluation value B decreases to or below the preset reference value Bset, the JPEG-compressed image data with an ID allocated in the imaging sequence is stored in the storage medium 53 via the input-output interface 52 (step S250). This terminates the image storage routine.

As described above, the digital camera 20 of the embodiment or its control method sets the compression rate ρ to decrease the computed block noise evaluation value B to or below the reference value Bset, which is set to the sufficiently small value incapable of evaluation of the block noise level by visual inspection, and then stores the JPEG-compressed image data with the set compression rate ρ in the storage medium 53. This arrangement enables the object image to be compressed with an adequate compression rate for storage in the storage medium 53.

The digital camera 20 of the embodiment or its control method evaluates the level of potential block noise, based on the smoothness degrees of luminance variation for the boundary pixels. This arrangement ensures adequate evaluation of the level of potential block noise. The block noise evaluation value B is given as the ratio of the average smoothness degree of luminance variation for the boundary pixels to the average smoothness degree of luminance variation for the inner pixels. In an image with a gentle variation in tone or brightness, the average smoothness degree of luminance variation for the boundary pixels is conspicuous to give a large block noise evaluation value B. In an image with a drastic variation in tone or brightness, on the other hand, the average smoothness degree of luminance variation for the boundary pixels is inconspicuous to give a small block noise evaluation value B. The evaluation result corresponding to the block noise evaluation value B thus well agrees with the evaluation result by visual inspection. This ensures the adequate evaluation of the level of potential block noise. The block noise evaluation value B varies in the range of 1 to 10. This enables numerical evaluation of the level of potential block noise. The adequate evaluation of the block noise level enables accurate judgment of the influence of potential noise arising in a compressed image and appropriate compression of the object image with an adequate compression rate for storage in the storage medium.

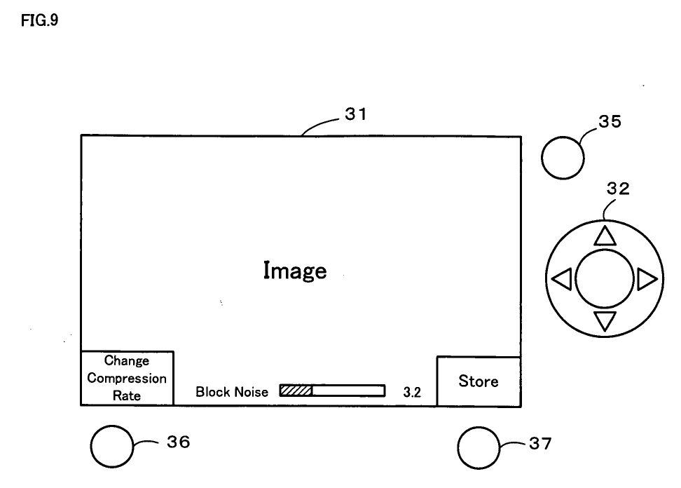

A digital camera 20B and its control method are described below as a second embodiment of the invention. The digital camera 20B of the second embodiment has an identical hardware configuration with that of the digital camera 20 of the first embodiment. The respective elements of the digital camera 20B of the second embodiment are thus expressed by the like numerals and symbols to those of the digital camera 20 of the first embodiment and are not specifically described here. In the second embodiment, another image storage routine shown in the flowchart of FIG. 8 is executed, instead of the image storage routine of the first embodiment shown in the flowchart of FIG. 7, when an image is taken with the digital camera 20B.

In the image storage routine of FIG. 8, the CPU 40a sets the default value to the compression rate ρ (step S300), compresses object image data by JPEG compression with the set compression rate ρ (step S310), and evaluates the level of potential block noise in the JPEG-compressed image according to the block noise level evaluation routine of FIG. 1 (step S320) The processing of steps S300 to S320 is identical with the processing of steps S200 to S220 in the image storage routine of FIG. 7. The CPU 40a then displays an operation window including the computed block noise evaluation value B on the liquid crystal display 31 (step S330). FIG. 9 shows one example of the operation window displayed on the liquid crystal display 31 on the rear face 30. In the illustrated example of FIG. 9, the object image is displayed in the operation window on the liquid crystal display 31, and the computed block noise evaluation value B is shown as both numerical representation and graphical representation (bar graph) on the bottom of the operation window. Options ‘Change Compression Rate’ and ‘Store’ respectively corresponding to the A button 36 and the B button 37 are shown on the lower left corner and the lower right corner in the operation window. The user manipulates the A button 36 under the display of this operation window to change the compression rate ρ in JPEG compression. The user manipulates the B button 37 under the display of this operation window to store the JPEG-compressed image data in the storage medium 53.

In response to the user's operation of either the A button 36 or the B button 37 under the display of the operation window, the CPU 40a identifies the operated button (step S340). When the user manipulates the A button 36 to select the option of changing the compression rate, the CPU 40a multiplies the compression rate ρ by a reduction factor k to reduce the compression rate ρ (step S350). The image storage routine then goes back to step S310 to compress the image data stored in the work memory 40c by JPEG compression with the reduced compression rate ρ. The CPU 40a then reevaluates the level of potential block nose (step S320) and redisplays the operation window including the updated block noise evaluation value B on the liquid crystal display 31 (step S330). In response to the user's manipulation of the A button 36 under the display of the operation window, this series of processing is repeated to reduce the compression rate ρ, compress the image data by JPEG compression with the reduced compression rate ρ, and evaluate the level of potential block noise.

When the user manipulates the B button 37 under the display of the operation window, the JPEG-compressed image data with an ID allocated in the imaging sequence is stored in the storage medium 53 via the input-output interface 52 (step S360). This terminates the image storage routine.

As described above, the digital camera 20B of the second embodiment or its control method enables the user to visually check the block noise evaluation value B of the JPEG-compressed object image, prior to storage. The compression rate ρ is changeable to an adequate value, and the object image is stored after JPEG compression with the adequate compression rate ρ. The level of potential block noise is evaluated according to the block noise level evaluation process shown in the flowchart of FIG. 1. This ensures adequate evaluation of the block noise level.

The digital camera 20B of the second embodiment or its control method shows every computation result of the block noise evaluation value B in the operation window on the liquid crystal display 31. One possible modification may show the computation result on the liquid crystal display 31 only when the computed block noise evaluation value B is not greater than a preset reference value. When the block noise evaluation value B is greater than the preset reference value, the compression rate ρ may be reduced automatically for subsequent JPEG compression without the user's check and button operation.

The digital camera 20B of the second embodiment or its control method shows the block noise evaluation value B as both the numerical representation and the graphical representation (bar graph) on the liquid crystal display 31. The block noise evaluation value B may be shown on the liquid crystal display 31 only by the graphical representation, for example, the bar graph, or may alternatively be shown only by the numerical representation.

In the digital camera 20 of the first embodiment, the digital camera 20B of the second embodiment, and their control methods, the block noise level evaluation process sets the average of the block noise evaluation value Bh in the horizontal direction and the block noise evaluation value By in the vertical direction to the block noise evaluation value B of the object image. One possible modification may compute only the block noise evaluation value Bh in the horizontal direction and set the computed block noise evaluation value Bh to the block noise evaluation value B of the object image. The possible modification may alternatively compute only the block noise evaluation value By in the vertical direction and set the computed block noise evaluation value By to the block noise evaluation value B of the object image. Such modification desirably reduces the load of calculating the block noise evaluation value B.

In the digital camera 20 of the first embodiment, the digital camera 20B of the second embodiment, and their control methods, the block noise level evaluation process uses the block noise evaluation value B in the range of 1 to 10 to evaluate the level of potential block noise. The block noise evaluation value B is, however, not restricted to this value range but may have any arbitrary value range, for example, a value range of 1 to 100.

In the digital camera 20 of the first embodiment, the digital camera 20B of the second embodiment, and their control methods, the block noise level evaluation process calculates the smoothness degrees of luminance variation with regard to all the pixels included in the object image. One possible modification calculates the smoothness degrees of luminance variation with regard to all the boundary pixels included in the object image, while calculating the smoothness degrees of luminance variation with regard to only part of the inner pixels, for example, pixels having the remainders of 1 and 4 by division of x or y values by 8 or pixels having the remainders of 2 and 6 by division of x or y values by 8.

The digital camera 20 of the first embodiment, the digital camera 20B of the second embodiment, or each of their control methods compresses an object image by JPEG compression in the units of blocks having 8 pixels in both the horizontal and the vertical directions, evaluates the level of potential block noise that may arise on each block boundary in the JPEG-compressed image, changes the compression rate to attain an allowable block noise level, and stores the compressed image with the allowable block noise level in the storage medium 53. The technique of the invention is, however, not restricted to such JPEG compression but is applicable to any image compression in the units of blocks of any preset vertical and horizontal dimensions.

The digital camera 20 of the first embodiment, the digital camera 20B of the second embodiment, or each of their control methods evaluates the level of potential block noise, changes the compression rate to attain an allowable block noise level, and stores the compressed image with the allowable block noise level in the storage medium 53. The compressed image with the default compression rate may also be stored in the storage medium 53.

The above embodiments regard the digital camera and its control method to compress an object image by JPEG compression, evaluate the level of potential block noise that may arise on each block boundary in the JPEG-compressed image, change the compression rate to attain an allowable block noise level, and store the compressed image with the allowable block noise level in the storage medium 53. The technique of the invention is also actualized by an image storage method.

The preferred embodiment and its modifications discussed above are to be considered in all aspects as illustrative and not restrictive. There may be many other modifications, changes, and alterations without departing from the scope or spirit of the main characteristics of the present invention.

The specification hereof refers to Japanese Patent Application No. 2004-140063 (filed on May 10, 2004) and No. 2004-140064 (filed on May 10, 2004), and incorporates herein all the details of the specification, the drawings, and the claims disclosed therein.

What is claimed is:

1. A block noise level evaluation method that evaluates a level of potential block noise arising on each block boundary in a compressed image, which is obtained by compression subsequent to division of an original image into multiple blocks of a preset number of pixels both in a horizontal direction and in a vertical direction,
said block noise level evaluation method comprising the steps of:
(a) calculating a luminance variation at each target pixel in the compressed image from luminance values of the target pixel and of an adjacent pixel adjoining to the target pixel in a preset direction;
(b) computing a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction;
(c) computing a block noise evaluation index from a specific ratio of an average smoothness degree of luminance variation for boundary pixels located on the block boundary to an average smoothness degree of luminance variation for inner pixels not located on the block boundary; and
(d) evaluating the level of potential block noise corresponding to the computed block noise evaluation index.

2. A block noise level evaluation method in accordance with claim 1, wherein the preset direction includes both the vertical direction and the horizontal direction.

3. A block noise level evaluation method in accordance with claim 2, wherein said step (c) computes the block noise evaluation index from an average of the specific ratio in the vertical direction and the specific ratio in the horizontal direction.

4. A block noise level evaluation method in accordance with claim 1, wherein the preset direction is either one of the vertical direction and the horizontal direction.

5. A block noise level evaluation method in accordance with claim 1, wherein said step (a) sets a difference between the luminance values of the target pixel and of the adjacent pixel adjoining to the target pixel in the preset direction to the luminance variation at the target pixel.

6. A block noise level evaluation method in accordance with claim 1, wherein said step (b) sets summation of absolute values of the anterior difference between the luminance variations at the target pixel and the anterior pixel in the preset direction and the posterior difference between the luminance variations at the target pixel and the posterior pixel in the preset direction to the smoothness degree of luminance variation at the target pixel.

7. A block noise level evaluation method in accordance with claim 1, wherein said step (c) computes the block noise evaluation index to increase with a rise in level of potential block noise.

8. A block noise level evaluation method in accordance with claim 7, wherein said step (c) computes the block noise evaluation index to have a numerical value in a value range of 1 to 10.

9. A block noise level evaluation method that evaluates a level of potential block noise arising on each block boundary in a compressed image, which is obtained by compression subsequent to division of an original image into multiple blocks of a preset number of pixels,
said block noise level evaluation method comprising the steps of:
(a) calculating a luminance variation at each target pixel in the compressed image from luminance values of the target pixel and of an adjacent pixel adjoining to the target pixel in a preset direction;
(b) computing a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction; and
(c) evaluating the level of potential block noise, based on the computed smoothness degrees of luminance variation for boundary pixels located on the block boundary.

10. A control method of an imaging device that stores a compressed image, which is obtained by compression subsequent to division of an original image into multiple blocks of a preset number of pixels both in a horizontal direction and in a vertical direction, into a storage medium,
said control method comprising the steps of:
(a) evaluating a level of potential block noise arising on each block boundary in the compressed image; and
(b) when the evaluated level of potential block noise is greater than a preset level, regenerating a compressed image with a reduced compression rate and reevaluating the level of potential block noise in the regenerated compressed image in said step (a),
when the evaluated level of potential block noise is not greater than the preset level, storing the compressed image into the storage medium.

11. A control method in accordance with claim 10, wherein said step (a) calculates a luminance variation at each target pixel in the compressed image from luminance values of the target pixel and of an adjacent pixel adjoining to the target pixel in a preset direction,
computes a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction,
computes a block noise evaluation index from a specific ratio of an average smoothness degree of luminance variation for boundary pixels located on the block boundary to an average smoothness degree of luminance variation for inner pixels not located on the block boundary, and
evaluates the level of potential block noise corresponding to the computed block noise evaluation index.

12. A control method in accordance with claim 11, wherein the preset direction includes both the vertical direction and the horizontal direction.

13. A control method in accordance with claim 12, wherein said step (a) computes the block noise evaluation index from an average of the specific ratio in the vertical direction and the specific ratio in the horizontal direction.

14. A control method in accordance with claim 11, wherein the preset direction is either one of the vertical direction and the horizontal direction.

15. A control method in accordance with claim 11, wherein said step (a) sets a difference between the luminance values of the target pixel and of the adjacent pixel adjoining to the target pixel in the preset direction to the luminance variation at the target pixel.

16. A control method in accordance with claim 11, wherein said step (a) sets summation of absolute values of the anterior difference between the luminance variations at the target pixel and the anterior pixel in the preset direction and the posterior difference between the luminance variations at the target pixel and the posterior pixel in the preset direction to the smoothness degree of luminance variation at the target pixel.

17. A control method in accordance with claim 11, wherein said step (a) computes the block noise evaluation index to increase with a rise in level of potential block noise.

18. A control method in accordance with claim 10, wherein said step (b) generates a compressed image with a predetermined compression rate set to a default.

19. A control method in accordance with claim 10, wherein when the evaluated level of potential block noise is greater than the preset level, said step (b) sequentially selects one of preset compression rates, which decrease stepwise, regenerates a compressed image with the selected compression rate and stores the compressed image.

20. A control method in accordance with claim 10, said control method further comprising the step of:
(c) displaying the evaluated level of potential block noise.

21. A control method in accordance with claim 20, wherein said step (c) displays the evaluated level of potential block noise by at least either of numerical representation and graphical representation.

22. A control method in accordance with claim 20, wherein in response to a user's instruction of generating a compressed image with a reduced compression rate, said step (b) generates the compressed image with the reduced compression rate and stores the compressed image.

23. An imaging device that stores a compressed image, which is obtained by compression subsequent to division of an original image into multiple blocks of a preset number of pixels both in a horizontal direction and in a vertical direction, into a storage medium,
said imaging device having a controller that performs control to evaluate a level of potential block noise arising on each block boundary in the compressed image, and
when the evaluated level of potential block noise is greater than a preset level, to regenerate a compressed image with a reduced compression rate and to reevaluate the level of potential block noise in the regenerated compressed image,
when the evaluated level of potential block noise is not greater than the preset level, to store the compressed image into the storage medium.

24. An image storage method that stores an image, said image storage method comprising the steps of:
(a) generating a compressed image by compression subsequent to division of an original image into multiple blocks of a preset number of pixels both in a horizontal direction and in a vertical direction;
(b) evaluating a level of potential block noise arising on each block boundary in the compressed image; and
(c) when the evaluated level of potential block noise is greater than a preset level, regenerating a compressed image with a reduced compression rate and reevaluating the level of potential block noise in the regenerated compressed image,
when the evaluated level of potential block noise is not greater than the preset level, storing the compressed image into the storage medium.

25. An image storage method in accordance with claim 24, wherein said step (b) calculates a luminance variation at each target pixel in the compressed image from luminance values of the target pixel and of an adjacent pixel adjoining to the target pixel in a preset direction,
computes a smoothness degree of luminance variation at the target pixel from an anterior difference between the calculated luminance variations at the target pixel and an anterior pixel adjoining to the target pixel in the preset direction and a posterior difference between the calculated luminance variations at the target pixel and a posterior pixel adjoining to the target pixel in the preset direction,
computes a block noise evaluation index from a specific ratio of an average smoothness degree of luminance variation for boundary pixels located on the block boundary to an average smoothness degree of luminance variation for inner pixels not located on the block boundary, and
evaluates the level of potential block noise corresponding to the computed block noise evaluation index.

26. An image storage method that stores an image, said image storage method comprising the step of:
when a level of potential block noise is greater than a preset level, generating a compressed image with a reduced compression rate and storing the compressed image,
when the level of potential block noise is not greater than the preset level, generating a compressed image with a predetermined compression rate and storing the compressed image.

27. An image storage method that stores an image, said image storage method comprising the step of:
when a level of potential block noise is greater than a preset level, storing a compressed image with a reduced compression rate and a compressed image with a predetermined compression rate.
